(19) United States
(12) Patent Application Publication
(10) Pub. No.: US 2016/0085723 A1
(43) Pub. Date: Mar. 24, 2016

(54) METHOD OF FINDING A MINIMUM AND MINIMUM FINDER UTILIZING THE SAME

(71) Applicant: NATIONAL TSING HUA UNIVERSITY, Hsinchu (TW)

(72) Inventors: Yeong-Luh Ueng, Hsinchu (TW); Mao-Ruei Li, Hsinchu (TW)

(21) Appl. No.: 14/614,372

(22) Filed: Feb. 4, 2015

(30) Foreign Application Priority Data
Sep. 18, 2014 (TW) 103132211

(51) Int. Cl. G06F 17/18

(52) U.S. Cl. CPC G06F 17/18

(57) ABSTRACT

A method of finding a minimum and a minimum finder utilizing the same are provided. The method, adopted by the minimum finder, determining a minimum and a probabilistic second minimum from a plurality of inputs, includes: providing a plurality of Minimum-Value Generators (MVG) to form a binary tree, wherein each MVG receives two of the plurality of inputs, compares the values of the two inputs to output a comparison result; and receiving, by a minimum-and-second-minimum generator, the comparison results of two of the plurality of MVGs to generate the minimum and the probabilistic second minimum; wherein the minimum-and-second-minimum generator is not connected to a MVG in a top layer of the binary tree.

### CROSS REFERENCE TO RELATED APPLICATIONS

This Application claims priority of Taiwan Patent Application No. 103132211, filed on Sep. 18, 2014, the entirety of which is incorporated by reference herein.

### BACKGROUND OF THE INVENTION

1. Field of the Invention

The present invention relates to signal processing, and in particular to a method of finding a minimum and minimum finder utilizing the same.

2. Description of the Related Art

A minimum finder circuit is a sorting circuit which searches for the minimum, the second minimum, the third minimum, or the nth minimum from a plurality of inputs, and finds many applications in digital communication systems. The circuit complexity, hardware area and computation duration of the minimum finder circuit increase exponentially as the number of inputs for comparison increases.

Therefore, a minimum finder circuit and a method thereof are required to effectively reduce the hardware area and circuit complexity while maintaining the system performance without considerable degradation.

### BRIEF SUMMARY OF THE INVENTION

A detailed description is given in the following embodiments with reference to the accompanying drawings.

An embodiment of a minimum finder is described, finding a minimum and a probabilistic second minimum from a plurality of inputs, comprising a plurality of minimum generators and a minimum and second minimum generator. The plurality of minimum generators are arranged in a form of a binary tree, wherein each minimum generator is configured to receive two of the plurality of inputs, and compare the two received inputs to generate a comparison result. The minimum and second minimum generator, connected to two of the plurality of minimum generators, is configured to receive the comparison results from the two of the plurality of minimum generators to generate the minimum and the probabilistic second minimum. The binary tree contains a top layer which receives the plurality of inputs. The minimum and second minimum generator is not connected to any minimum generator in the top layer of the binary tree.

Another embodiment of a method of finding a minimum and a probabilistic second minimum from a plurality of inputs is disclosed, adopted by a minimum finder, the method comprising: providing a plurality of minimum generators arranged in a form of a binary tree, wherein each minimum generator is configured to receive two of the plurality of inputs, and compare the two received inputs to generate a comparison result; and receiving, by a minimum and second minimum generator, the comparison results from the two of the plurality of minimum generators to generate the minimum and the probabilistic second minimum; wherein the binary tree contains a top layer which receives the plurality of inputs; and the minimum and second minimum generator is not connected to any minimum generator in the top layer of the binary tree.

### BRIEF DESCRIPTION OF THE DRAWINGS

The present invention can be more fully understood by reading the subsequent detailed description and examples with references made to the accompanying drawings, wherein:

FIG. 1 is a block diagram of a minimum finder 1 according to an embodiment of the invention.

FIGS. 2A and 2B illustrate circuit schematics of the MVG1 and MVG2 according to embodiments of the invention.

FIG. 3 illustrates a circuit schematic of the connection unit CU 12 according to an embodiment of the invention.

FIG. 4A is a schematic diagram of a minimum finder according to an embodiment of the invention.

FIG. 4B illustrates impacts of the indices of the connection units in the minimum finder in FIG. 4A on the overall system performance.

FIG. 5 is a flowchart of a method 5 of finding a minimum according to an embodiment of the invention

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

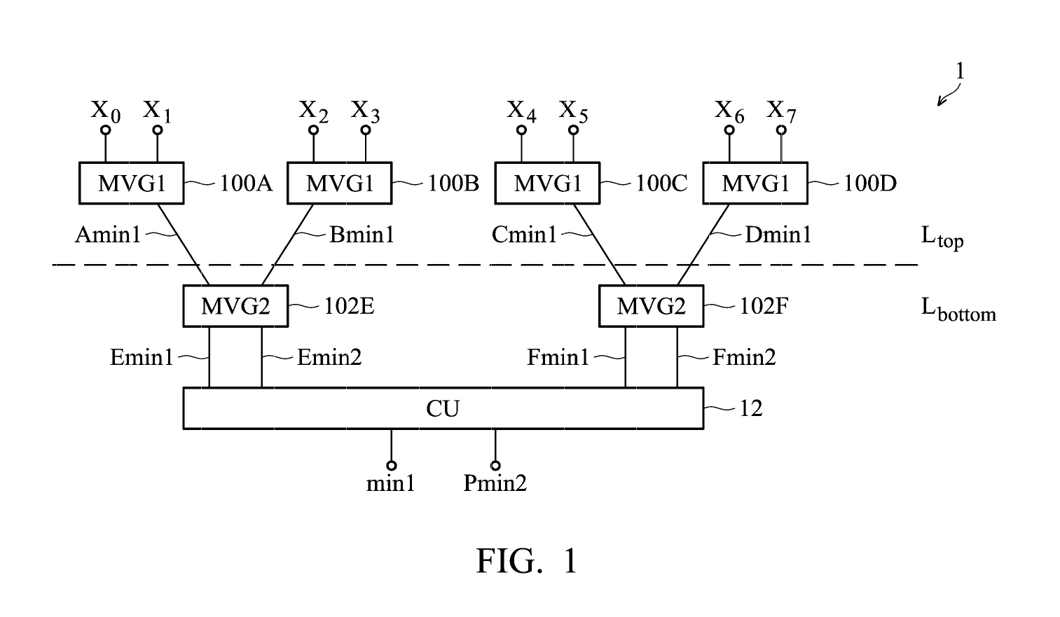

FIG. 1 is a block diagram of a minimum finder 1 according to an embodiment of the invention, including a plurality of Minimum Value Generators (MVG) 100A through 100D and 102E through 102F and a Connection Unit (CU) 12 (minimum and second minimum generator). The minimum finder 1 can find an absolute minimum min1 and a probabilistic second minimum Pmin2 from a plurality of inputs X0 through X7. The absolute minimum min1 is the correct minimum among the inputs X0 through X7, while the probabilistic second minimum Pmin2 may or may not be the correct second minimum among the inputs X0 through X7.

As shown in FIG. 1, a plurality of MVGs 100A through 100D and 102E through 102F are arranged in the form of a binary tree. Each MVG can receive two inputs and compare magnitudes of the inputs to generate a comparison result. The MVGs in FIG. 1 have two types, one being MVG1 which outputs the smaller value of the two inputs, the other being MVG2 which outputs the smaller value and the larger value of the two inputs. The binary tree includes two or more layers of MVGs, where the topmost layer Lₜₒₚ, made up of MVG1, receives the plurality of inputs X0 through X7 and outputs the smaller values of the two inputs to the lower layers, the bottommost layer L_{bottom}, made up of MVG2, outputs the smaller values and larger values of the two inputs to the CU 12. The MVG1 in the topmost layer will not be connected to any CU 12, whereas the MVG2 in the bottommost layer will be certainly connected to a CU 12.

Each CU is connected to two MVG2, and receives the smaller value and the larger value output from the MVG2 to generate the minimum and the probabilistic second minimum of the four inputs received from the previous two minimum value generators MVG2. For example, the CU 12 is connected to the MVG2 102E and 102F, receives the smaller value Emin1 and the larger value Emin2 from the MVG2 102E and the smaller value Fmin1 and the larger value Fmin2 from the MVG2 102F, and finds the minimum min1 and the probabilistic second minimum Pmin2 among the four inputs. Specifically, the CU 12 selects the real minimum min1 from the smaller values Emin1 and Fmin1, and subsequently selects the probabilistic second minimum Pmin2 based on the previous comparison result. Meanwhile, the CU 12 can output the indices q1 and q2 which corresponds to the minimum min1 and the probabilistic second minimum Pmin2.

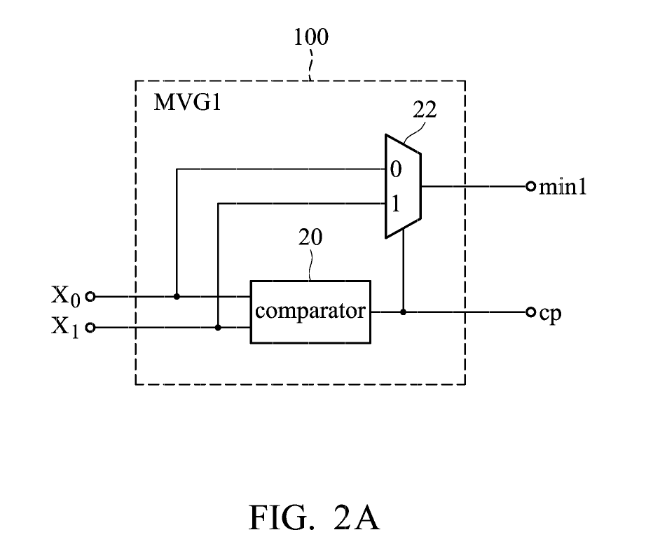

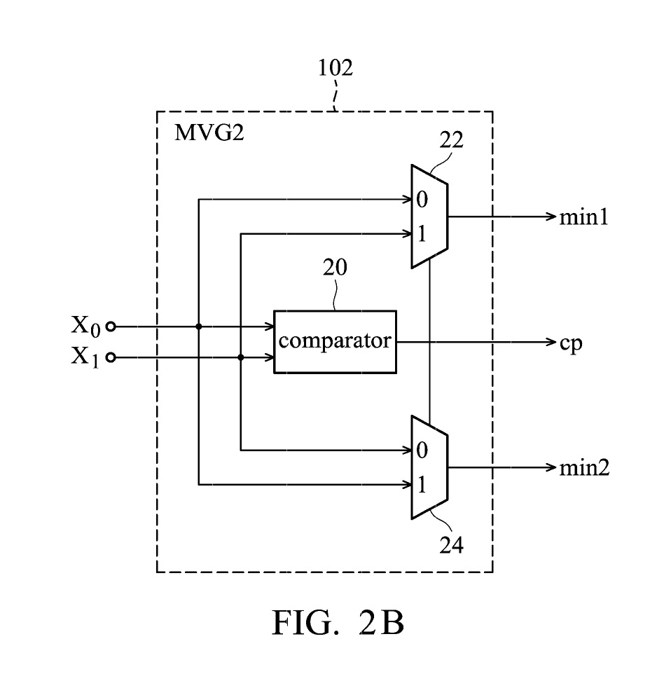

Please refer to FIGS. 2A and 2B, illustrating circuit schematics of the MVG1 and MVG2, respectively. The MVG1 in FIG. 2A includes a comparator 20 and a multiplexer 22. The comparator 20 may compare the magnitudes of the two inputs X0 and X1 and output the comparison result cp. In certain embodiments, when the input X0 is less than X1, the comparison result cp is 0, otherwise, the comparison result cp is 1. The multiplexer 22 may receive the two inputs X0 and X1 and select an output min1 based on the comparison result cp. For example, when the comparison result cp is 0, the multiplexer 22 will output the input X0 as the smaller value min1, whereas when the comparison result cp is 1, the multiplexer 22 will output the input X1 as the smaller value min1. In comparison to the MVG1 in FIG. 2A, the MVG2 in FIG. 2B further includes a multiplexor 24, which may similarly receive the two inputs X0 and X1 and select an output min2 based on the comparison result cp. For example, when the comparison result cp is 0, the multiplexer 24 will output the input X1 as the larger value min2, whereas when the comparison result cp is 1, the multiplexer 24 will output the input X0 as the larger value min2. Since the circuit area of the MVG1 is less than that of the MVG2, adopting the MVG1 in place of the MVG2 may reduce the circuit area of the minimum finder 1.

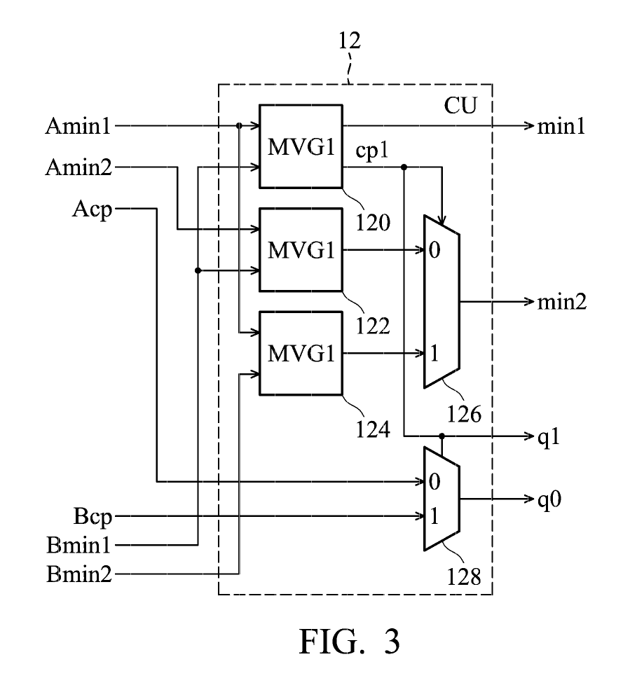

Next please refer to FIG. 3, illustrating a circuit schematic of the connection unit CU 12 according to an embodiment of the invention. The connection unit CU 12 includes MVG1 120, 122 and 124 (the first, second, and third minimum generators) and multiplexers 126 and 128. The connection unit CU 12 is connected to two MVG2 from the previous layer, and the MVG 1 in the CU 12 may receive the smaller values Amin1 and Bmin1 from the two MVG2 of the previous layer, compare the smaller values Amin1 and Bmin1 to select the real minimum min1, and select the probabilistic second minimum Pmin2 according to the comparison result cp1 and the index q0 thereof. The CU 12 may output the comparison result cp1 as the index q1 of minimum min1. The MVG1 122 may receive the larger value Amin2 and the smaller value Bmin1 of the two MVG2 of the previous layer to generate the smaller value of the two inputs. Likewise, the MVG1 124 may receive the larger value Bmin2 and the smaller value Amin1 of the two MVG2 of the previous layer to generate the smaller value of the two inputs. The multiplexer 126 may output the output of the MVG1 122 or 124 as the probabilistic second minimum Pmin2 based on the comparison result cp1. Concurrently, the multiplexer 128 may select the index q0 of the probabilistic second minimum Pmin2 from the output results Acp and Bcp from the two MVG2 of the previous layer based on the comparison result cp1 of the MVG1.

Returning to FIG. 1, since the MVG1 only outputs the smaller value min1 of the two inputs, when the correct minimum and the correct second minimum among all inputs X0 through X7 are both output to the same MVG1, the MVG1 will only output one value as the output value min1 and leave out the other one, consequently the correct second minimum cannot be passed to the MVG2 of the last layer L_{bottom}. As such, the probabilistic second minimum Pmin2 will not be the correct second minimum. Nevertheless, if the correct minimum and the correct second minimum among all inputs X0 through X7 are arranged as the inputs of the left half MVG1 100A and 100B and the right half MVG1 100C and 100D, respectively, the probabilistic second minimum Pmin2 will be the correct second minimum.

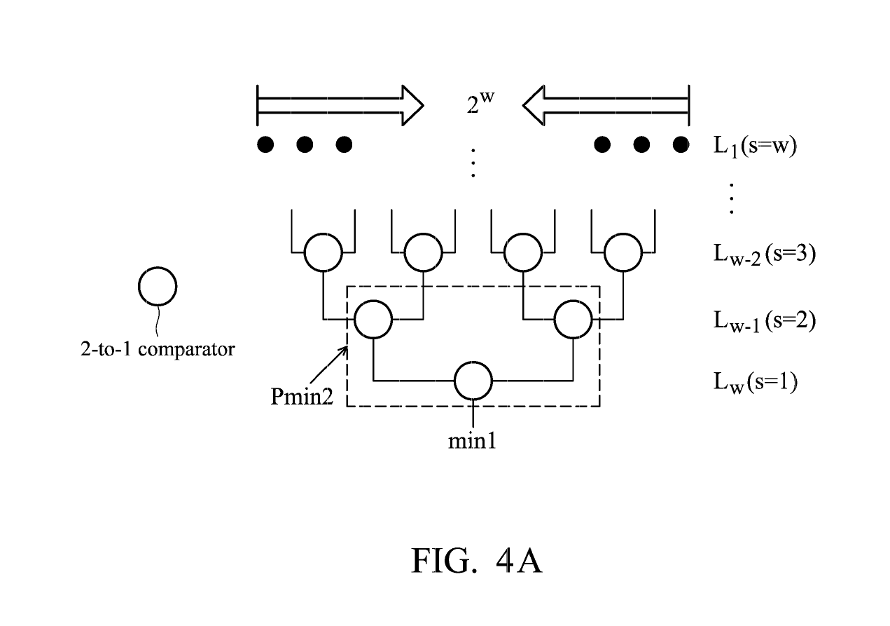

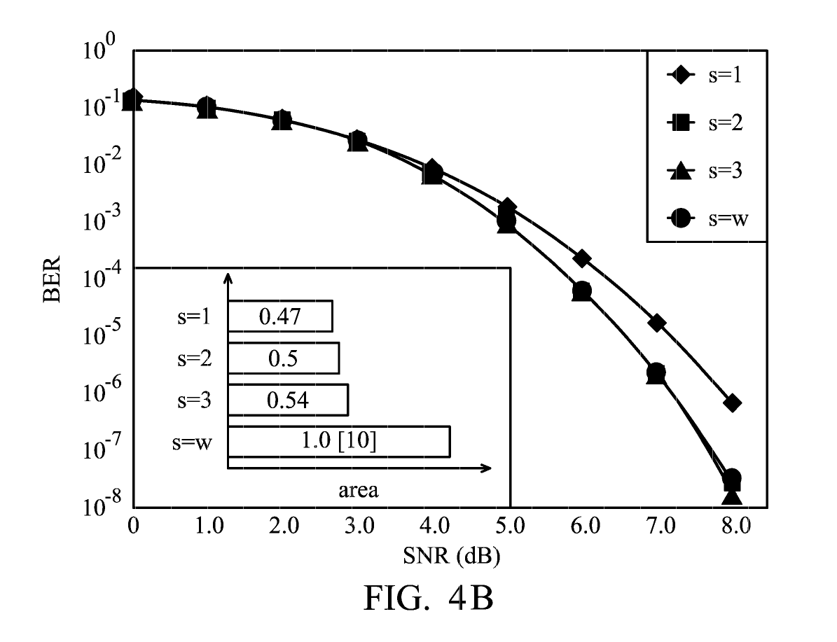

FIG. 1 only shows an 8-input, 2-layer binary tree. In practice, the minimum finder 1 may receive more than 8 inputs, and the binary tree may contain more than 2 layers. When the concept of the minimum finder 1 is applied for 2^{w} inputs, the 2^{w} inputs are divided into 2 groups, each group of 2^{w-1} inputs is compared to determine a smaller value and a larger value, and then the CU receives the smaller and larger values to determine the minimum and the probabilistic second minimum and the indices thereof. Moreover, only the MVG2 can be connected to the CU, and the CU can be connected to the MVG2 in layers other than the topmost layer Lₜₒₚ, which only contains MVG1. FIGS. 4A and 4B illustrate embodiments in which the CU is coupled to the MVG2 in another layer. The circuit area and complexity of the minimum finder 1 increases proportionally with the number of the CUs, and so does the probability of finding the probabilistic second minimum as being the correct second minimum. FIG. 4B shows that the system performance improves with the increase of the number of the CUs.

In order to decrease the circuit area and circuit complexity, the minimum finder 1 only includes the CU 12 at the bottom layer of the binary tree to generate the probabilistic second minimum Pmin2. The probabilistic second minimum Pmin2 may or may not be, but is highly probable of being, the correct second minimum among the inputs X0 through X7. Referring to FIGS. 4A and 4B, which show that the probability of the probabilistic second minimum Pmin2 being the correct second minimum increases with the layer in which the CUs are included. FIG. 4A is a schematic diagram of the minimum finder according to an embodiment of the invention, wherein a comparison tree receiving 2^{w} inputs is provided, each circle represents a 2-to-1 comparator, or the MVG. The 2-to-1 comparator is arranged to contain layers L₁ through L_{w}, with a depth of w, where the layer L₁ is the first layer (the topmost layer) of the comparison tree, and the layer L_{w} is the w^{th} layer (the bottommost layer) of the comparison tree.

s is defined as the level of the comparison tree in which the CU is included. When the CU is connected to the MVG in the bottommost layer L_{w} of the comparison tree, s=1, the CU at the bottommost layer L_{w} can output the minimum min1 and the probabilistic second minimum Pmin2. When the probability of the correct second minimum is evenly distributed among the 2^{w} inputs, the probability of the probabilistic second minimum Pmin2 being the correct second minimum is 2^{(w-1)}/2^{w}−1, or approximately 50%. When the CUs are connected to the MVGs in the bottommost layer L_{w} and the second to the last layer of the comparison tree, s=2, the CU at the bottommost layer L_{w} can output the minimum min1 and the probabilistic second minimum Pmin2, and the probability of the probabilistic second minimum Pmin2 being the correct second minimum is 3•2^{(w-1)}/2^{w}−1, or approximately 75%. When the CUs are connected to the MVGs in all the layers of the comparison tree, s=w, the CU at the bottommost layer L_{w} can output the minimum min1 and the probabilistic second minimum Pmin2, and the probability of the probabilistic second minimum Pmin2 being the correct second minimum is 100%. Each CU occupies finite circuit space and routing, thus the circuit area and circuit complexity of the minimum finder increases with the number of CUs. It can be recognized from the above embodiment, that the probability of the probabilistic second minimum Pmin2 being the correct second minimum, and, increases with the level of the comparison tree in which the CUs are included, as does circuit area and circuit complexity.

In certain embodiments, the minimum finder is adopted in a digital circuit implementing Low-Density Parity-Check (LDPC) decoders or other error correction decoders employing soft information, e.g., using Chase algorithm to decode a Bose, Ray-Chaudhuri and Hocquenghem (BCH) code. In the above applications, adopting the probabilistic second minimum Pmin2 will not severely degrade the Bit Error Rate (BER) of the final output data. The embodiments in the invention only include the CU(s) to the last level or the last few levels of the comparison tree, and as a consequence, although an incorrect second minimum may be output, the decoding performance may remain the same by using the correction second minimum, while the circuit area is reduced.

FIG. 4B depicts a relationship of the circuit area and the data quality (BER) with respect to the level in the minimum finder which the connection units are connected to, as shown in FIG. 4A. As illustrated by the curve of the BER performance in FIG. 4B, when the CU is only added to the last level of the comparison tree (S=1), the BER after adopting the BCH code with the Chase algorithm becomes slightly worse than that of adding the CUs to all levels (s=w) of the comparison tree at high Signal-to-Noise Ratio (SNR). If the CUs are added to several higher levels (s=2 or s=3), the BER of the data is almost the same as the BER of the data of adding the CUs to all levels (s=w) of the comparison tree. The bar diagram on the left bottom corner illustrates that the circuit area of the minimum finder decreases with the level of the comparison tree in which the CUs are added.

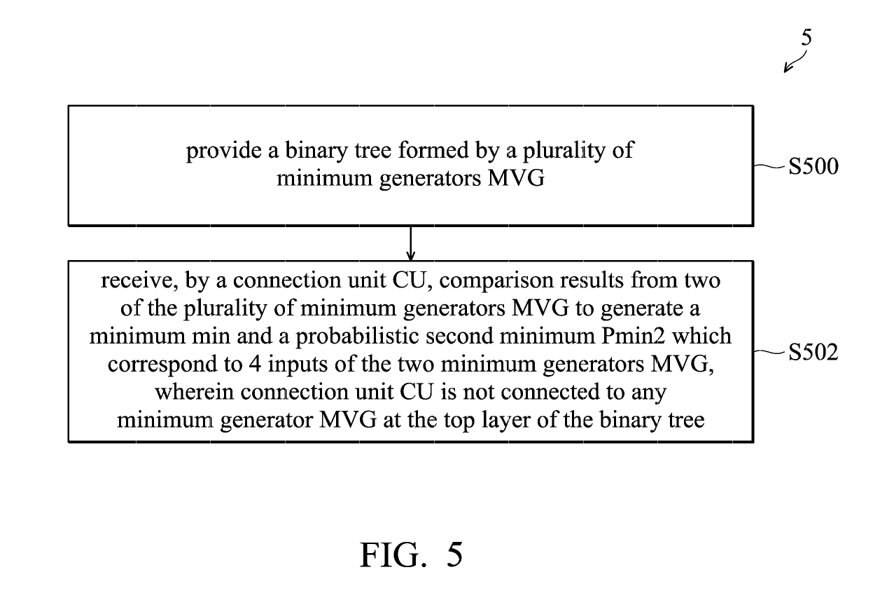

FIG. 5 is a flowchart of a method 5 of finding a minimum according to an embodiment of the invention, incorporating the minimum finder in FIG. 1 or FIG. 4A.

In Step S500, the method 5 provides the binary tree which is formed by a plurality of the minimum generators MVG, and the topmost layer of the binary tree receives the plurality of inputs 2^{w}.

In Step S502, the comparison results cp generated by two minimum generators MVG are received by the connection unit CU to generate the minimum min1 and the probabilistic second minimum Pmin2 among the plurality of inputs 2^{w}, wherein the connection units CU are only included in the last level, the last 2 levels, or the last several levels and are not connected to the minimum generators MVG in the topmost layer of the binary tree. In some embodiments, the connection unit CU is only connected to the minimum generators MVG in the bottommost layer of the binary tree. In other embodiments, the connection units CU are only connected to the minimum generators MVG in the bottommost layer and the second to last layer of the binary tree. In some embodiments, the connection unit CU further receives the indices of the smaller values of the two minimum generators MVG from the previous layer to generate the indices q1 and q0 corresponding to the minimum min1 and the probabilistic second minimum Pmin2.

The embodiments of the method of finding the minimum and the minimum finder only include the connection units CU at the last level, the last two levels, or the last few levels, and as a consequence, despite the possibility for an incorrect second minimum to be output, the decoding performance may remain the same by using the correct second minimum, while the circuit area is reduced considerably.

In addition, the various illustrative logical blocks, modules, and circuits described in connection with the aspects disclosed herein may be implemented within or performed by an integrated circuit (“IC”), an access terminal, or an access point. The IC may comprise a general-purpose processor, a digital signal processor (DSP), an application specific integrated circuit (ASIC), a field programmable gate array (FPGA) or another programmable logic device, discrete gate or transistor logic, discrete hardware components, electrical components, optical components, mechanical components, or any combination thereof designed to perform the functions described herein, and may execute codes or instructions that reside within the IC, outside the IC, or both. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the invention has been described in connection with various aspects, it should be understood that the invention is capable of further modifications. This application is intended to cover any variations, uses or adaptation of the invention following, in general, the principles of the invention, and including such departures from the present disclosure as falling within the known and customary practice within the art to which the invention pertains.

What is claimed is:

1. A minimum finder, finding a minimum and a probabilistic second minimum from a plurality of inputs, comprising:
a plurality of minimum generators, arranged in a form of a binary tree, wherein each minimum generator is configured to receive two of the plurality of inputs, and compare the two received inputs to generate a comparison result; and
a minimum and second minimum generator, connected to two of the plurality of minimum generators, configured to receive the comparison results from the two of the plurality of minimum generators to generate the minimum and the probabilistic second minimum;
wherein the binary tree contains a top layer which receives the plurality of inputs; and
the minimum and second minimum generator is not connected to any minimum generator in the top layer of the binary tree.

2. The minimum finder of claim 1, wherein the binary tree contains a bottom layer including only two minimum generators; and
the minimum and second minimum generator is only connected to the only two minimum generators in the bottom layer of the binary tree.

3. The minimum finder of claim 1, wherein each minimum generator is configured to generate an index corresponding to a smaller one of the two of the plurality of inputs; and
the minimum and second minimum generator is configured to receive the index corresponding to a smaller value to generate indices of the minimum and the probabilistic second minimum.

4. The minimum finder of claim 1, wherein each minimum generator comprises:
a comparator, configured to compare the two of the plurality of inputs to generate the comparison result; and
a first multiplexer, coupled to the comparator, configured to generate a smaller input of the two of the plurality of inputs based on the comparison result.

5. The minimum finder of claim 4, wherein:
each minimum generator further comprises a second multiplexer, coupled to the comparator, configured to generate a larger input of the two of the plurality of inputs based on the comparison result; and
the minimum and second minimum generator further comprises:
a first minimum generator, configured to compare two smaller inputs from the two connected minimum generators to generate the minimum; and
two second minimum generators, configured to compare a larger input from one of the two connected minimum generators with a smaller input from the other one of the two connected minimum generators, respectively, to generate the probabilistic second minimum.

6. A method of finding a minimum and a probabilistic second minimum from a plurality of inputs, adopted by a minimum finder, the method comprising:
providing a plurality of minimum generators arranged in a form of a binary tree, wherein each minimum generator is configured to receive two of the plurality of inputs, and compare the two received inputs to generate a comparison result; and
receiving, by a minimum and second minimum generator, the comparison results from the two of the plurality of minimum generators to generate the minimum and the probabilistic second minimum;
wherein the binary tree contains a top layer which receives the plurality of inputs; and
the minimum and second minimum generator is not connected to any minimum generator in the top layer of the binary tree.

7. The method of claim 6, wherein the binary tree contains a bottom layer including only two minimum generators; and
the minimum and second minimum generator is only connected to the only two minimum generators in the bottom layer of the binary tree.

8. The method of claim 6, further comprising:
generating, by each minimum generator, an index corresponding to a smaller one of the two of the plurality of inputs; and
receiving, by the minimum and second minimum generator, the index corresponding to a smaller value to generate indices of the minimum and the probabilistic second minimum.

9. The method of claim 6, wherein each minimum generator comprises:
a comparator, configured to compare the two of the plurality of inputs to generate the comparison result; and
a first multiplexer, coupled to the comparator, configured to generate a smaller input of the two of the plurality of inputs based on the comparison result.

10. The method of claim 9, wherein:
each minimum generator further comprises a second multiplexer, coupled to the comparator, configured to generate a larger input of the two of the plurality of inputs based on the comparison result; and
the minimum and second minimum generator further comprises:
a first minimum generator, configured to compare two smaller inputs from the two connected minimum generators to generate the minimum; and
second and third minimum generators, configured to compare a larger input from one of the two connected minimum generators with a smaller input from the other one of the two connected minimum generators, respectively, to generate the probabilistic second minimum.
